(19) United States
(12) Patent Application Publication
(10) Pub. No.: US 2011/0234522 A1
(43) Pub. Date: Sep. 29, 2011

(54) TOUCH SENSING METHOD AND SYSTEM USING THE SAME

(75) Inventors: Ching-Chun Lin, Taipei County (TW); Wing-Kai Tang, Hsinchu City (TW); Hao-Jan Huang, Hsinchu City (TW); Ching-Ho Hung, Hsinchu City (TW); Tsen-Wei Chang, Taichung County (TW); Jiun-Jie Tsai, Hsinchu City (TW)

(73) Assignee: NOVATEK MICROELECTRONICS CORP., Hsinchu (TW)

(21) Appl. No.: 13/069,410

(22) Filed: Mar. 23, 2011

(30) Foreign Application Priority Data
Mar. 25, 2010 (TW) 99108929

(51) Int. Cl. G06F 3/041

(52) U.S. Cl. 345/173

(57) ABSTRACT

A touch sensing system including a touch interface and a control unit is provided. The touch interface senses at least one edge change of at least one region on the touch interface corresponding to at least one object. The control unit defines a touch gesture corresponding to the object according to the edge change so as to perform a touch operation corresponding to the touch gesture. Additionally, a touch sensing method is also provided. In the touch sensing method, whether the touch gesture is a moving gesture, a rotation gesture, a flip gesture, a zoom-in gesture, or a zoom-out gesture is determined according to any change of a touch region.

### CROSS-REFERENCE TO RELATED APPLICATION

This application claims the priority benefit of Taiwan application serial no. 99108929, filed Mar. 25, 2010. The entirety of the above-mentioned patent application is hereby incorporated by reference herein and made a part of this specification.

### BACKGROUND OF THE INVENTION

1. Field of the Invention

The invention generally relates to a sensing method and a system using the same, and more particularly, to a touch sensing method and a system using the same.

2. Description of Related Art

In this information era, reliance on electronic products is increasing day by day. The electronic products including notebook computers, mobile phones, personal digital assistants (PDAs), digital walkmans, and so on are indispensable in our daily lives. Each of the aforesaid electronic products has an input interface for a user to input his or her command, such that an internal system of each of the electronic product spontaneously runs the command.

In order to provide a more intuitional operation mode, electronic product manufactures start to dispose touch input interfaces, such as touch pads and touch panels, on electronic products such that users can input instructions through these touch pads and touch panels. An existing touch input interface usually works by detecting the touching or sensing action between a finger (or stylus) and the touch input interface, so that the electronic apparatus can define a touch gesture of the user according to the change of the coordinates of the touch point or the change of the number of touch points and perform a corresponding operation according to the touch gesture.

### SUMMARY OF THE INVENTION

Accordingly, the invention is directed to a touch sensing method in which a touch gesture is defined according to an edge change of a region on a touch interface corresponding to an object, and a corresponding touch operation is performed according to the touch gesture.

The invention is directed to a touch sensing system in which a touch gesture is defined according to an edge change of a region on a touch interface corresponding to an object, and a corresponding touch operation is performed according to the touch gesture.

The invention provides a touch sensing method adapted to a touch sensing system, wherein the touch sensing system includes a touch interface. The touch sensing method includes following steps. At least one edge change of at least one region on the touch interface corresponding to at least one object is sensed within a timing tolerance. A touch gesture corresponding to the object is defined according to the edge change.

According to an embodiment of the invention, the step of sensing the edge change includes following steps. A first edge of the region in a direction is sensed at a first time within the timing tolerance. A second edge of the region in the direction is sensed at a second time within the timing tolerance. Whether a distance between the first edge and the second edge is greater than a change threshold is determined. The distance is defined as the edge change if the distance is greater than the change threshold, wherein the value of the edge change is the distance, and the direction of the edge change is aforementioned direction.

According to an embodiment of the invention, the touch sensing method further includes following steps. The touch gesture is defined as a moving gesture towards aforementioned direction according to the direction of the edge change.

According to an embodiment of the invention, the step of sensing the edge change includes following steps. A first edge change of the region corresponding to the object is sensed during a first period within the timing tolerance. A second edge change of the region corresponding to the object is sensed during a second period within the timing tolerance. The direction of the first edge change is a first direction, and the direction of the second edge change is a second direction.

According to an embodiment of the invention, the touch sensing method further includes following steps. A rotation judgment sequence is performed according to an area change of the region. Whether an angle between the first direction and the second direction is greater than a first angle threshold is determined. The touch gesture is defined as a rotation gesture if the angle is greater than the first angle threshold.

According to an embodiment of the invention, the touch sensing method further includes following steps. A flip judgment sequence is performed according to an area change of the region. Whether an angle between the first direction and the second direction is greater than a second angle threshold is determined. The touch gesture is defined as flip gesture if the angle is greater than the second angle threshold.

According to an embodiment of the invention, the step of sensing the edge change includes following steps. A third edge change of a first region corresponding to the object is sensed during a third period within the timing tolerance. A fourth edge change of a second region corresponding to the object is sensed during the third period within the timing tolerance.

According to an embodiment of the invention, the touch sensing method further includes following steps. A zoom-in judgment sequence is performed according to area changes of the first region and the second region. Whether a distance between the first region and the second region is smaller than a first distance threshold is determined. The touch gesture is defined as a zoom-in gesture if the distance is smaller than the first distance threshold.

According to an embodiment of the invention, the touch sensing method further includes following steps. A zoom-out judgment sequence is performed according to area changes of the first region and the second region. Whether a distance between the first region and the second region is greater than a second distance threshold is determined. The touch gesture is defined as a zoom-out gesture if the distance is greater than the second distance threshold.

According to an embodiment of the invention, the touch sensing method further includes performing a touch operation according to the touch gesture.

The invention provides a touch sensing system including a touch interface and a control unit. The touch interface senses at least one edge change of at least one region on the touch interface corresponding to at least one object within a timing tolerance. The control unit defines a touch gesture corresponding to the object according to the edge change.

According to an embodiment of the invention, when the touch interface senses the edge change, the touch interface senses a first edge of the region in a direction at a first time within the timing tolerance, and the touch interface senses a second edge of the region in the direction at a second time within the timing tolerance, and the control unit determines whether a distance between the first edge and the second edge is greater than a change threshold. The control unit defines the distance as the edge change if the distance is greater than the change threshold, wherein the value of the edge change is the distance, and the direction of the edge change is aforementioned direction.

According to an embodiment of the invention, the control unit defines the touch gesture as a moving gesture towards aforementioned direction according to the direction of the edge change.

According to an embodiment of the invention, when the touch interface senses the edge change, the touch interface senses a first edge change of the region corresponding to the object during a first period within the timing tolerance, and the touch interface senses a second edge change of the region corresponding to the object during a second period within the timing tolerance, wherein the direction of the first edge change is a first direction, and the direction of the second edge change is a second direction.

According to an embodiment of the invention, the control unit performs a rotation judgment sequence according to an area change of the region and determines whether an angle between the first direction and the second direction is greater than a first angle threshold. The control unit defines the touch gesture as a rotation gesture if the angle is greater than the first angle threshold.

According to an embodiment of the invention, the control unit performs a flip judgment sequence according to an area change of the region and determines whether an angle between the first direction and the second direction is greater than a second angle threshold. The control unit defines the touch gesture as a flip gesture if the angle is greater than the second angle threshold.

According to an embodiment of the invention, when the touch interface senses the edge change, the touch interface senses a third edge change of a first region corresponding to the object during a third period within the timing tolerance, and the touch interface senses a fourth edge change of a second region corresponding to the object during the third period within the timing tolerance.

According to an embodiment of the invention, the control unit performs a zoom-in judgment sequence according to area changes of the first region and the second region and determines whether a distance between the first region and the second region is smaller than a first distance threshold. The control unit defines the touch gesture as a zoom-in gesture if the distance is smaller than the first distance threshold.

According to an embodiment of the invention, the control unit performs a zoom-out judgment sequence according to area changes of the first region and the second region and determines whether a distance between the first region and the second region is greater than a second distance threshold. The control unit defines the touch gesture as a zoom-out gesture if the distance is greater than the second distance threshold.

According to an embodiment of the invention, the control unit performs a touch operation according to the touch gesture.

As described above, in a touch sensing system provided by an embodiment of the invention, a touch gesture is defined according to an edge change of a region on the touch interface corresponding to an object, and a corresponding operation is performed according to the touch gesture. Additionally, in a touch sensing method provided by an embodiment of the invention, whether a touch gesture is a moving gesture, a rotation gesture, a flip gesture, a zoom-in gesture, or a zoom-out gesture is determined according to any change of a touch region. Thereby, application of touch sensing technique is made more diversified.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A-1C are diagrams respectively illustrating how a user touches a touch interface with his finger.

FIG. 1D is a diagram illustrating different regions on the touch interface touched by the user's finger.

FIG. 1E and FIG. 1F respectively illustrate different time intervals for a touch sensing system to sense edge changes of a touch region within a specific timing tolerance according to an embodiment of the invention.

FIG. 2 is a circuit block diagram of a touch sensing system according to an embodiment of the invention.

FIGS. 3A-3D illustrate changes of a region on a touch interface touched by a user's finger according to embodiments of the invention.

FIG. 4 is a flowchart illustrating the steps in a touch sensing method for defining a moving gesture according to an embodiment of the invention.

FIG. 5A illustrates how a region on a touch interface touched by a user's finger changes over time according to another embodiment of the invention.

FIG. 5B illustrates how a region on a touch interface touched by a user's finger changes over time according to yet another embodiment of the invention.

FIG. 6 is a flowchart illustrating the steps in a touch sensing method for defining a rotation gesture according to an embodiment of the invention.

FIG. 7A illustrates how a region on a touch interface touched by a user's finger changes over time according to another embodiment of the invention.

FIG. 7B illustrates how a region on a touch interface touched by a user's finger changes over time according to yet another embodiment of the invention.

FIG. 8 is a flowchart illustrating the steps in a touch sensing method for defining a flip gesture according to an embodiment of the invention.

FIG. 9A illustrates edge changes of a multi-touch region according to an embodiment of the invention.

FIG. 9B illustrates edge changes of a multi-touch region according to another embodiment of the invention.

FIG. 10 is a flowchart illustrating the steps in a touch sensing method for defining a zoom-in or a zoom-out gesture according to an embodiment of the invention.

FIG. 11 is a flowchart of a touch sensing method according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In the embodiments provided hereinafter, touch panels and users' fingers exemplarily act as touch interfaces and touching objects, while people having ordinary skill in the art are aware that the touch panels and the users' fingers do not pose a limitation on the touch interfaces and the touching objects of the invention, and any input interface capable of sensing touching objects does not depart from the protection scope of the invention.

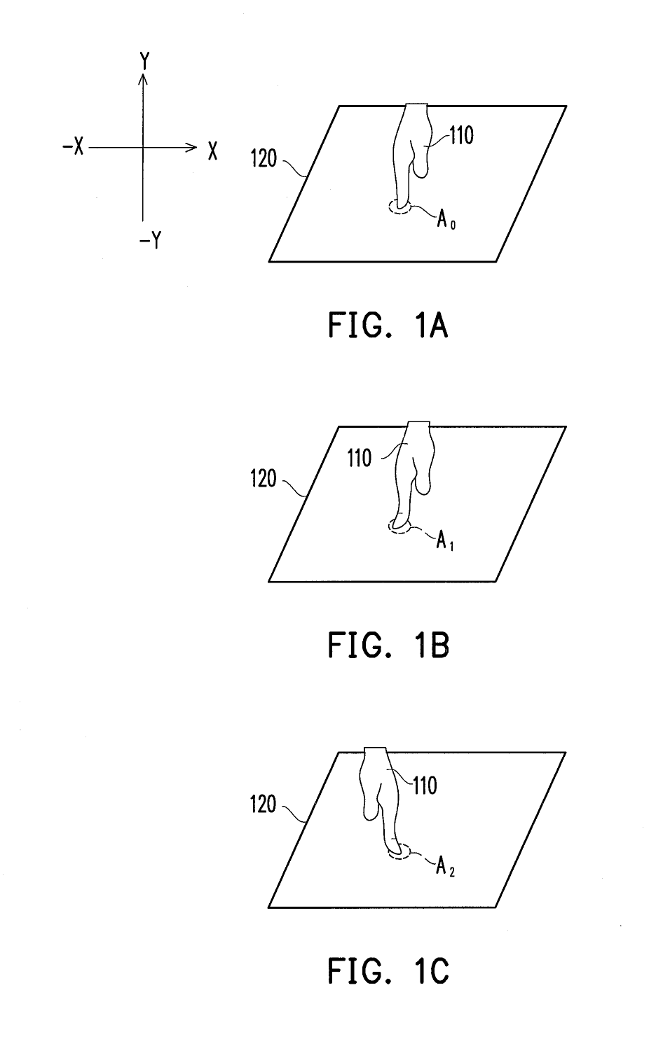

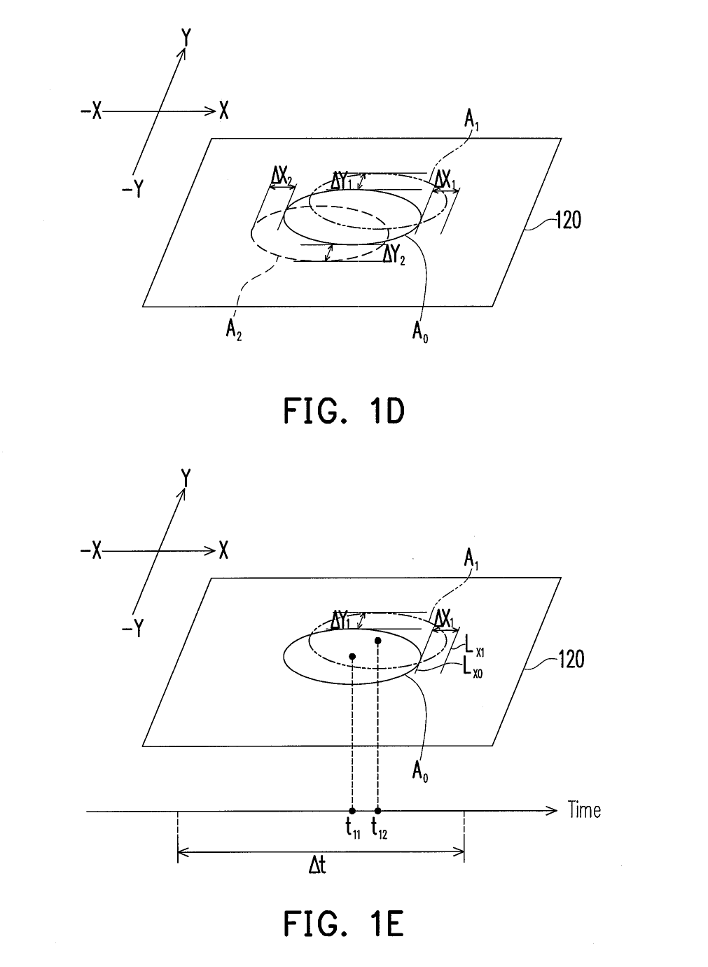

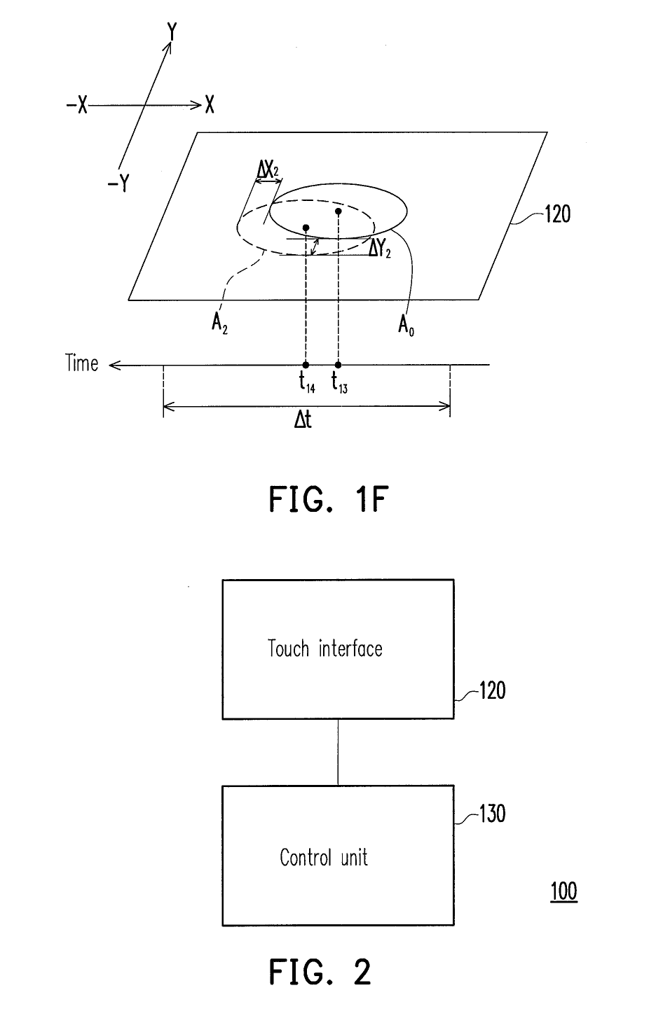

FIGS. 1A-1C are diagrams respectively illustrating how a user touches a touch interface with his finger. FIG. 1D is a diagram illustrating different regions on the touch interface touched by the user's finger. Referring to FIGS. 1A-1D, in FIG. 1A, the region touched by the user with his finger 110 on the touch interface 120, for example, is the region A₀ shown in FIG. 1D, and in FIG. 1B and FIG. 1C, the regions touched by the user with his finger 110 on the touch interface 120, for example, are respectively the regions A₁ and A₂ shown in FIG. 1D. Herein the touch interface 120 may be a touch panel or any interface that can be operated through touch.

FIG. 1E and FIG. 1F respectively illustrate different time intervals for a touch sensing system to sense edge changes of a touch region within a specific timing tolerance Δt according to an embodiment of the invention. Referring to FIGS. 1A-1F, in FIG. 1E, the finger 110 touches the touch interface 120 at time t₁₁ in such a way as illustrated in FIG. 1A. Thus, the touch region currently sensed by the touch interface 120, for example, is the region A₀. Then, the finger 110 touches the touch interface 120 at time t₁₂ in such a way as illustrated in FIG. 1B. Thus, the touch region currently sensed by the touch interface 120, for example, is the region A₁.

Accordingly, at time t₁₂, the distance between the region A₁ and the region A₀ in the +X-direction, for example, is ΔX₁, and the distance between the region A₁and the region A₀ in the +Y-direction, for example, is ΔY₁. Namely, during the period t₁₁-t₁₂, the touch region between the finger 110 and the touch interface 120 changes from the region A₀ to the region A₁, the edge change in the +X-direction is ΔX₁, and the edge change in the +Y-direction is ΔY₁. Herein the edge change ΔX₁, for example, is defined as the shortest distance between the edge tangents of the regions A₀ and A₁ in the +X-direction, and the edge change ΔY₁, for example, is defined as the shortest distance between the edge tangents of the regions A₀ and A₁ in the +Y-direction.

It should be noted that in FIG. 1E, even though the touch region between the finger 110 and the touch interface 120 changes, the finger 110 remains in contact with the touch interface 120 and does not leave the surface of the touch interface 120 during the course of the change. Namely, the region A₀ is substantially the same as the region A₁, and the two regions are regions on the touch interface 120 touched by the same object at different time.

Similarly, in FIG. 1F, the finger 110 touches the touch interface 120 at time t₁₃ in such a way as illustrated in FIG. 1A, and the finger 110 touches the touch interface 120 at time t₁₄ in such a way as illustrated in FIG. 1C. In other words, during the period t₁₃-t₁₄ illustrated in FIG. 1F, the touch region between the finger 110 and the touch interface 120 changes from the region A₀ to the region A₂, the edge change in the −X-direction is ΔX₂, and the edge change in the −Y-direction is ΔY₂. Herein the edge change ΔX₂ is defined as the shortest distance between the edge tangents of the regions A₀ and A₂ in the −X-direction, and the edge change ΔY₂ is defined as the shortest distance between the edge tangents of the regions A₀ and A₂ in the −Y-direction.

It should be noted that in the present embodiment, even though the touch region between the finger 110 and the touch interface 120 changes during the period t₁₃-t₁₄, the finger 110 remains in contact with the touch interface 120 and does not leave the surface of the touch interface 120 during the course of the change. Thus, the region A₀ is substantially the same as the region A₂, and the two regions are regions on the touch interface 120 touched by the same object at different time.

Additionally, in FIGS. 1A-1F, a round shape or an elliptical shape is exemplary for the touch region between the finger 110 and the touch interface 120. However, the invention is not limited thereto.

In following exemplary embodiments, when a round region or an elliptical region is exemplary for the touch region between the finger 110 and the touch interface 120 (for example, the one illustrated in FIG. 1D), the edge change of the touch region refers to the shortest distance between the edge tangents of different regions, such as the regions A₀ and A₁ or the regions A₀ and A₂, in the same direction.

FIG. 2 is a circuit block diagram of a touch sensing system according to an embodiment of the invention. Referring to FIG. 2, in the present embodiment, the touch sensing system 100 includes a touch interface 120 and a control unit 130. The touch interface 120 senses at least one edge change of at least one region on the touch interface 120 corresponding to at least one object within a specific timing tolerance. The control unit 130 defines a touch gesture of the object according to the edge change sensed by the touch interface 120.

To be specific, referring to FIGS. 1A-1F and FIG. 2, in the present embodiment, the touch interface 120, for example, is a touch panel, and the object sensed thereby, for example, is the finger 110 of a user illustrated in FIG. 1A.

In the present embodiment, when the touch interface 120 senses the edge change, the touch interface 120 senses a first edge of the touch region in a direction at a first time within the specific timing tolerance, and the touch interface 120 senses a second edge of the touch region in the direction at a second time within the specific timing tolerance.

Taking the +X-direction in FIG. 1E as an example, when the finger 110 touches the touch interface 120 for the first time, the touch interface 120 senses an edge tangent L_{X0} of the region A₀ on the touch interface 120 touched by the finger 110 in the +X-direction within the specific timing tolerance Δt. For example, if the finger 110 touches the region A₀ on the touch interface 120 at time t₁₁ (as shown in FIG. 1E), the first edge sensed by the touch interface 120 at time t₁₁ (i.e., the first time) is the edge tangent L_{X0} illustrated in FIG. 1E.

Next, when the touch region between the finger 110 and the touch interface 120 changes, the touch interface 120 senses an edge tangent L_{X1} of the region A₁ on the touch interface 120 touched by the finger 110 in the +X-direction. Namely, if the finger 110 touches the region A₁ on the touch interface 120 at time t₁₂ (as shown in FIG. 1E), the second edge sensed by the touch inter face 120 at time t₁₂ (i.e., the second time) is the edge tangent L_{X1} illustrated in FIG. 1E.

After that, the control unit 130 determines whether the distance between the edge tangent L_{X0} and the edge tangent L_{X1} is greater than a change threshold. If the distance is greater than the change threshold, the control unit 130 defines the distance as the edge change ΔX₁ in the +X-direction and continues to execute the touch sensing method in the present embodiment. In the present embodiment, the edge change ΔX₁ is a vector, the value thereof is the distance between the edge tangent L_{X0} and the edge tangent L_{X1}, and the direction thereof is the +X-direction.

Thus, when the control unit 130 determines the distance between the edge tangent L_{X0} and the edge tangent L_{X1} to be the edge change ΔX₁ in the +X-direction , the control unit 130 defines a touch gesture corresponding to the finger 110 according to the edge change ΔX₁. For example, if the touch region between the finger 110 and the touch interface 120 changes in the +X-direction as that illustrated in FIG. 1E, the control unit 130 defines the touch gesture to be a moving gesture towards the +X-direction according to the direction of the edge change ΔX₁.

Similarly, when the touch region between the finger 110 and the touch interface 120 changes in the +Y-direction as that illustrated in FIG. 1E, the control unit 130 defines the touch gesture to be a moving gesture towards the +Y-direction according to the direction of the edge change ΔY₁.

It should be noted that in the embodiment illustrated in FIG. 1E, the edge change of the region A₀ includes the edge change ΔX₁ and the edge change ΔY₁. Thus, the control unit 130 defines the direction of the moving gesture based on the direction determined by both the edge change ΔX₁ and the edge change ΔY₁. Namely, in the present embodiment, the control unit 130 performs a vector operation on the edge changes ΔX₁ and ΔY₁ to obtain a vector, and the control unit 130 defines the direction of the moving gesture as the direction of the vector and defines the moving distance of the moving gesture according to the value of the vector.

Thus, in the present embodiment, the control unit 130 defines a touch gesture corresponding to the finger 110 according to the edge change of the region A₀ and further defines the touch gesture as a moving gesture towards a specific direction, so as to perform a corresponding touch operation.

Similarly, in the present embodiment, if the edge change of the touch region between the finger 110 and the touch interface 120 is as illustrated in FIG. 1F, the control unit 130 performs a vector operation on the edge changes ΔX₂ and ΔY₂ and defines the direction and moving distance of the moving gesture according to the obtained vector.

Additionally, in the present embodiment, the first edge refers to the edge tangent of the region on the touch interface 120 corresponding to the finger 110 in a specific direction when the finger 110 touches the touch interface 120 for the first time, and the second edge refers to another edge tangent of the region on the touch interface 120 corresponding to the finger 110 in the specific direction when the touch region between the finger 110 and the touch interface 120 changes.

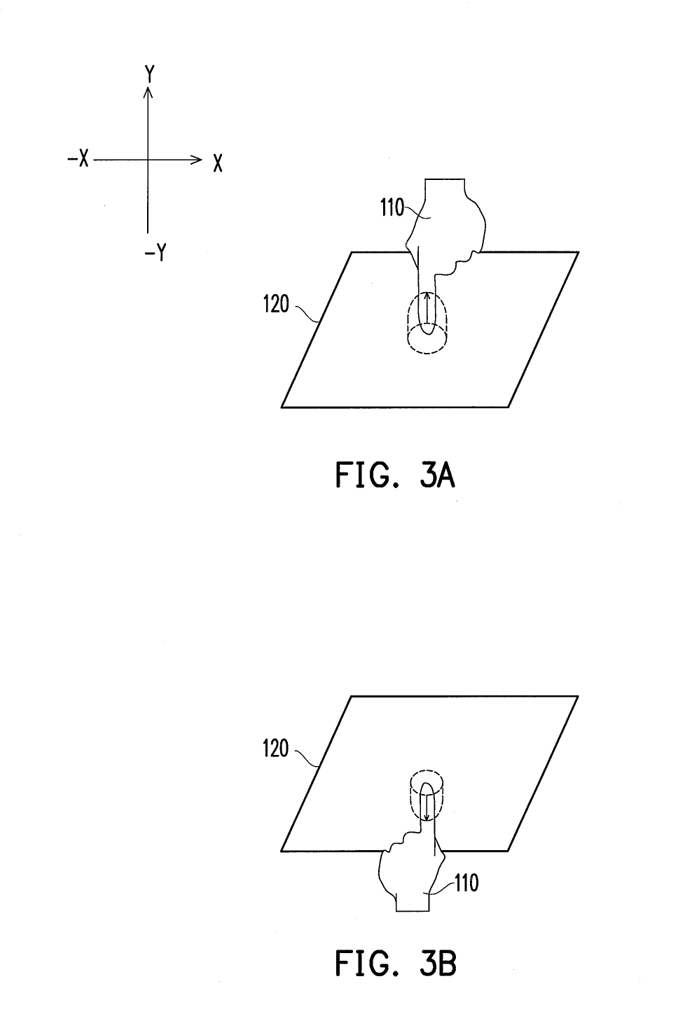

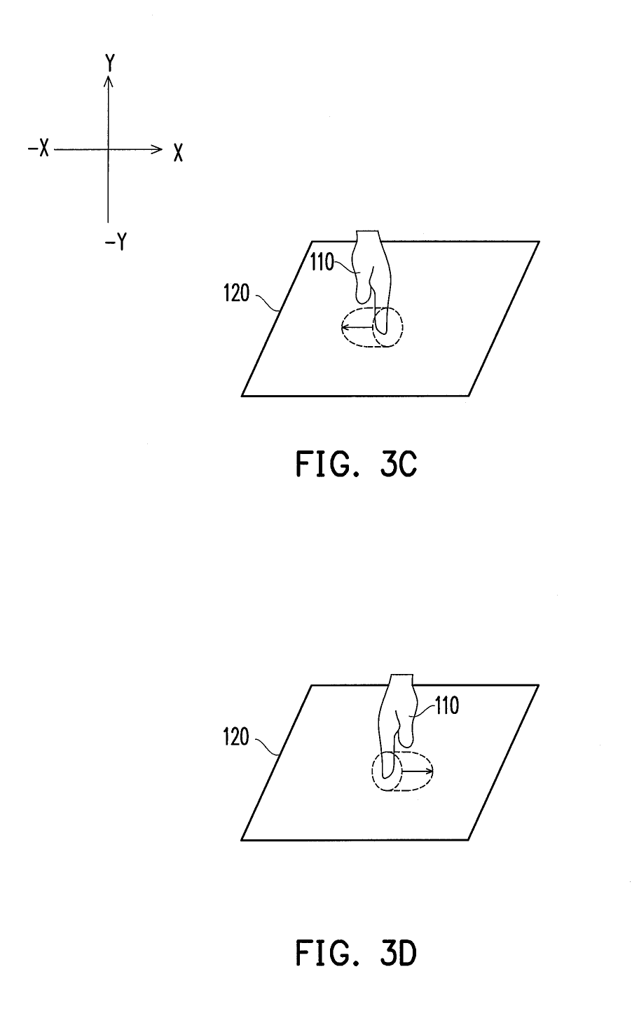

FIGS. 3A-3D illustrate changes of a region on a touch interface touched by a user's finger according to embodiments of the invention. Referring to FIG. 2 and FIGS. 3A-3D, in the embodiment illustrated in FIGS. 3A-3D, the control unit 130 respectively defines a touch gesture of the finger 110 as a moving gesture in different direction according to the corresponding edge change.

For example, in FIG. 3A, the touch interface 120 senses within the specific timing tolerance that the direction of the edge change of the region corresponding to the finger 110 is the +Y-direction. Thus, the control unit 130 defines the touch gesture of the finger 110 as a moving gesture towards the +Y-direction according to the edge change, so as to perform the corresponding touch operation.

Similarly, in FIGS. 3B-3D, the control unit 130 respectively defines the touch gesture of the finger 110 as a moving gesture towards the −Y-direction, the −X-direction, and the +X-direction according to the direction of the corresponding edge change.

It should be noted that in the embodiment described above, even though the touch region between the user's finger and the touch interface changes within the specific timing tolerance, the user's finger remains in contact with the touch interface and does not leave the surface of the touch interface during the course of the change. Thus, in the embodiment described above, to depart from conventional techniques, the touch sensing system defines a moving gesture according to an edge change of the touch region so that application of the moving gesture is made more diversified.

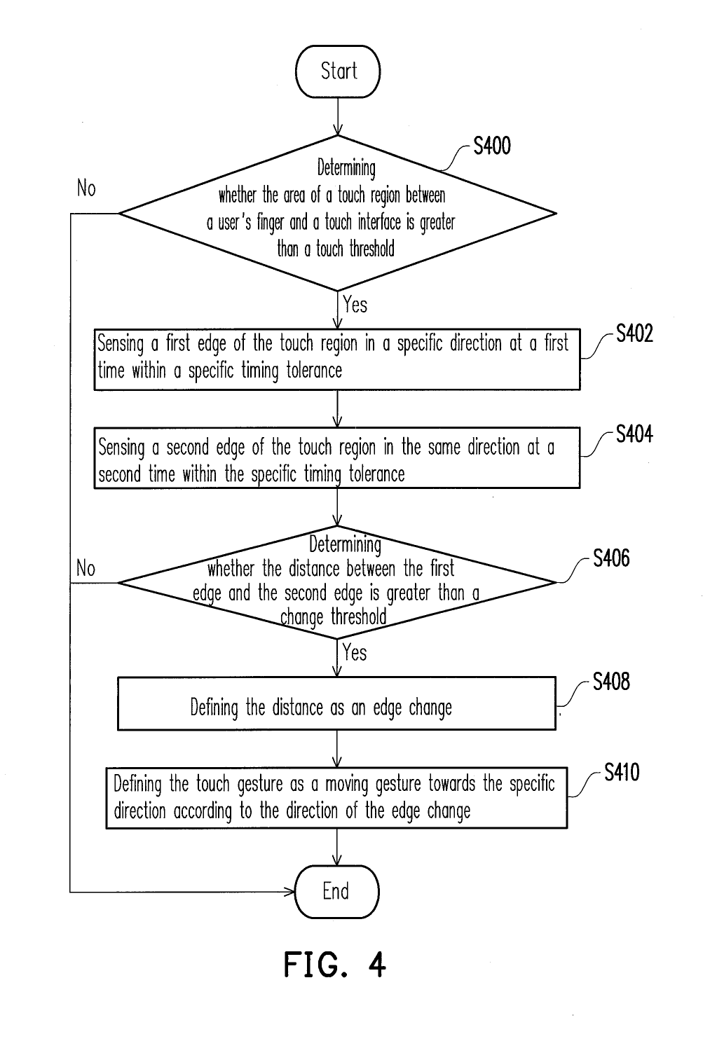

FIG. 4 is a flowchart illustrating the steps in a touch sensing method for defining a moving gesture according to an embodiment of the invention.

Referring to FIG. 4, first, in step S400, whether the area of the touch region between the user's finger and the touch interface is greater than a touch threshold is determined. If the area of the touch region between the user's finger and the touch interface is greater than the touch threshold, in step S402, a first edge of the touch region in a specific direction is sensed at a first time within a specific timing tolerance. Then, in step S404, a second edge of the touch region in the same direction is sensed at a second time within the specific timing tolerance. Next, in step S406, whether the distance between the first edge and the second edge is greater than a change threshold is determined. If the distance is greater than the change threshold, in step S408, the distance is defined as an edge change, wherein the value of the edge change is the distance, and the direction of the edge change is aforementioned direction. Finally, in step S410, the touch gesture is defined as a moving gesture towards the specific direction according to the direction of the edge change, so as to perform a corresponding touch operation.

Besides, the touch sensing method described in this embodiment of the invention is sufficiently taught, suggested, and embodied in the embodiments illustrated in FIG. 1D to FIG. 3D, and therefore no further description is provided herein.

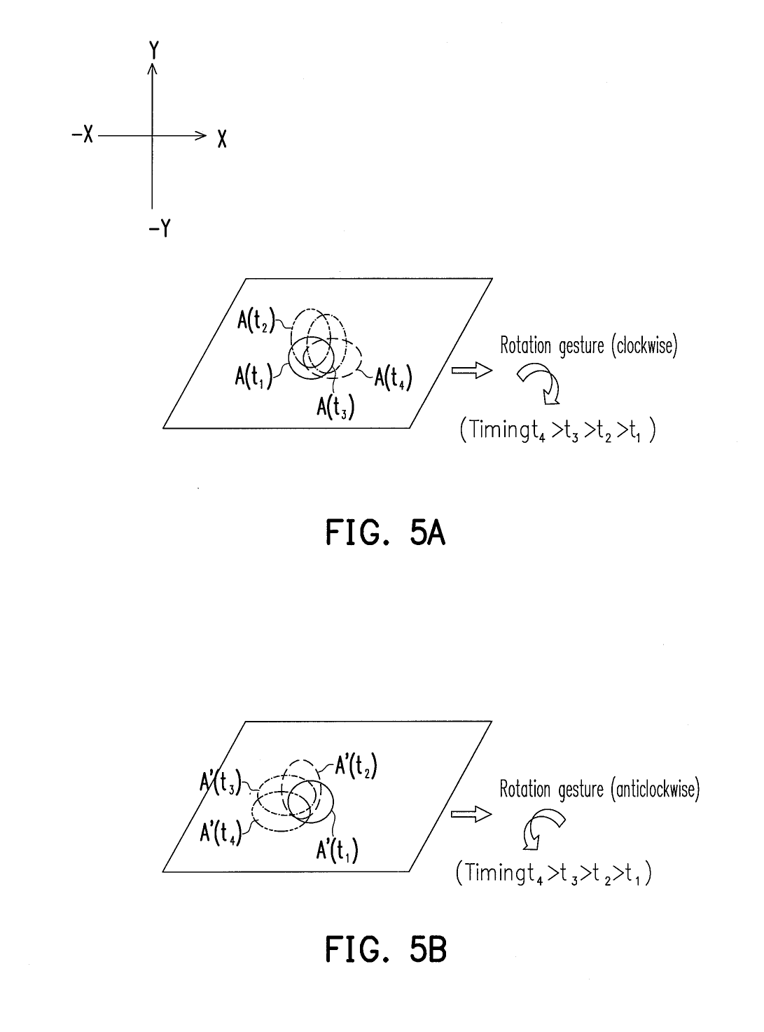

FIG. 5A illustrates how a region on a touch interface touched by a user's finger changes over time according to another embodiment of the invention. Referring to FIG. 2 and FIG. 5A, in the present embodiment, the user sequentially touches the regions A (t₁), A (t₂), A (t₃), and A (t₄) on the touch interface 120 over time with his finger 110. Meanwhile, the touch interface 120 sequentially senses the edge changes of the region A (t₁) over time within the specific timing tolerance Δt. Thus, control unit 130 defines the touch gesture of the user's finger according to the edge changes of the region A (t₁) over time. Herein, the timings have such a sequence as t₁<t₂<t₃<t₄.

To be specific, the edge change sensed by the touch interface 120 during the period t₁-t₂ may be in the +Y-direction. The edge change sensed by the touch interface 120 during the period t₂-t₃ may be in a specific direction between the directions of +Y and +X. The edge change sensed by the touch interface 120 during the period t₃-t₄ may be in the +X-direction. Herein the direction of the edge change sensed during the period t₂-t₃ is the direction of an edge change between the regions A (t₃) and A (t₁), and the direction of the edge change sensed during the period t₃-t₄ is the direction of an edge change between the regions B(t₄) and B(t₁).

Thus, the control unit 130 defines the touch gesture of the user's finger as a rotation gesture in the clockwise direction (as shown in FIG. 5A) according to the edge changes of the region A (t₁) during the periods t₁-t₂, t₂-t₃, and t₃-t₄.

To be specific, in order to prevent the control unit 130 from defining the touch gesture as a moving gesture in the +Y-direction according to the direction of the edge change during the period t₁-t₂, the control unit 130 first determines whether an area change of the region A (t₁) satisfies a condition of performing a rotation judgment sequence. The control unit 130 performs the rotation judgment sequence only if the area change of the region A (t₁) satisfies the condition of performing the rotation judgment sequence. For example, if the area change of the region A (t₁) tallies with the area changes of the regions A (t₂) and A (t₃) during the period t₂-t₃, the control unit 130 performs the rotation judgment sequence to define the touch gesture of the user's finger as a rotation gesture in the clockwise direction.

In addition, before defining the touch gesture of the user's finger as a rotation gesture in the clockwise direction, the control unit 130 first determines whether an angle between the directions of the edge changes at time t₂ and time t₄ is greater than a first angle threshold. If the angle is greater than the first angle threshold, the control unit 130 defines the touch gesture as a rotation gesture. For example, in the present embodiment, the angle between the directions of the edge changes at time t₂ and time t₃ is assumed to be the first angle threshold. If the angle between the directions of the edge changes at time t₂ and time t₄ is greater than the angle between the directions of the edge changes at time t₂ and time t₃, the control unit 130 defines the touch gesture as a rotation gesture. In the present embodiment, the directions of the edge changes at time t₂ and time t₄ are substantially perpendicular to each other. Thus, the control unit 130 defines the touch gesture as a rotation gesture.

In other words, the control unit 130 performs a rotation judgment sequence according to an area change of the touch region and determines whether the angle between the first direction (the direction of the edge change at time t₂) and the second direction (the direction of edge change at time t₄) is greater than a first angle threshold (the angle between the directions of the edge changes at time t₂ and time t₃). If the angle between the first direction and the second direction is greater than the first angle threshold, the control unit 130 defines the touch gesture as a rotation gesture. In the present embodiment, the first direction and the second direction are substantially perpendicular to each other.

It should be noted that in FIG. 5A, even though the touch region between the finger 110 and the touch interface 120 changes, the finger 110 remains in contact with the touch interface 120 and does not leave the surface of the touch interface 120 during the course of the change. Namely, the regions A (t₁), A (t₂), A (t₃), and A (t₄) at different time points can be substantially considered as the same region, and which are the regions on the touch interface 120 corresponding to the same object at different time.

FIG. 5B illustrates how a region on a touch interface touched by a user's finger changes over time according to yet another embodiment of the invention. Referring to FIG. 2 and FIG. 5B, in the present embodiment, the user sequentially touches the regions A′ (t₁), A′ (t₃), and A′ (t₄) on the touch interface 120 with his finger 110 over time. Meanwhile, the touch interface 120 sequentially senses the edge changes of the region A′ (t₁) over time within a specific timing tolerance Δt. Thus, the control unit 130 defines a touch gesture of the user's finger according to the edge changes of the region A′ (t₁) over time. Herein the timings have such a sequence as t₁<t₂<t₃<t₄.

To be specific, the edge change sensed by the touch interface 120 during the period t₁-t₂ is in the +Y-direction. However, unlike in the embodiment illustrated in FIG. 5A, in the present embodiment, the edge change sensed by the touch interface 120 during the period t₂-t₃ may be in a specific direction between the directions of +Y and −X. Then, the edge change sensed by the touch interface 120 during the period t₃-t₄ may be in the −X-direction. Herein the direction of the edge change during the period t₂-t₃ is the direction of an edge change between the regions A′ (t₃) and A′ (t₁), and the direction of the edge change during the period t₃-t₄ is the direction of an edge change between the regions A′ (t₄) and A′ (t₁).

Thus, the control unit 130 defines the touch gesture of the user's finger as a rotation gesture in the anticlockwise direction (as shown in FIG. 5B) according to the edge changes of the region A′ (t₁) during the periods t₁-t₂, t₂-t₃, and t₃-t₄.

It should be noted that the value of the first angle threshold (i.e., the angle between the directions of the edge changes at time t₂ and time t₃) in the present embodiment may be the same as or different from that in the embodiment illustrated in FIG. 5A.

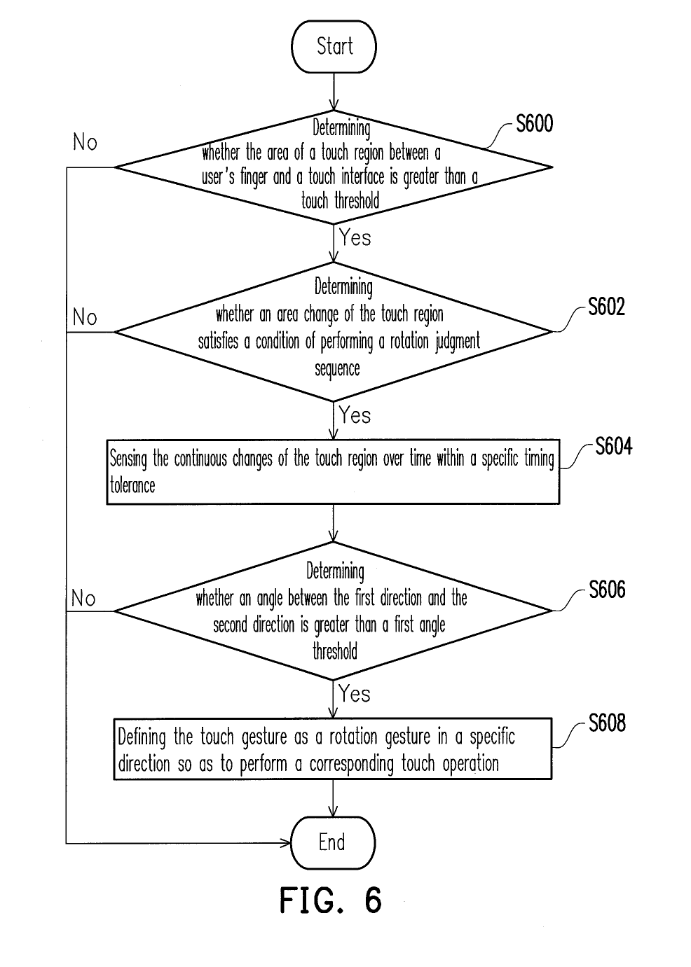

FIG. 6 is a flowchart illustrating the steps in a touch sensing method for defining a rotation gesture according to an embodiment of the invention.

Referring to FIG. 6, first, in step S600, whether the area of the touch region between a user's finger and a touch interface is greater than a touch threshold is determined. If the area of the touch region between the user's finger and the touch interface is greater than a touch threshold, in step S602, whether an area change of the touch region satisfies a condition of performing a rotation judgment sequence is determined. If the area change of the touch region satisfies the condition of performing the rotation judgment sequence, in step S604, the continuous changes of the touch region over time are sensed within a specific timing tolerance. Then, in step S606, whether an angle between the first direction and the second direction is greater than a first angle threshold is determined. If the angle between the first direction and the second direction is greater than the first angle threshold, in step S608, the touch gesture is defined as a rotation gesture in a specific direction so as to perform a corresponding touch operation.

Besides, the touch sensing method described in this embodiment of the invention is sufficiently taught, suggested, and embodied in the embodiments illustrated in FIG. 5A and FIG. 5B, and therefore no further description is provided herein.

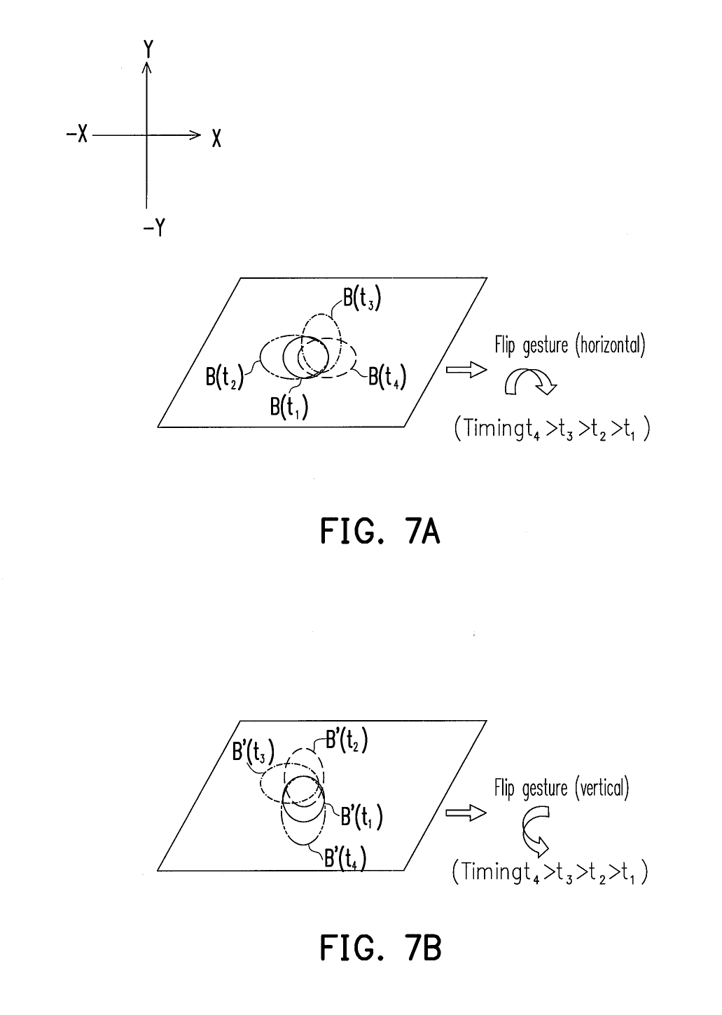

FIG. 7A illustrates how a region on a touch interface touched by a user's finger changes over time according to another embodiment of the invention. Referring to FIG. 2 and FIG. 7A, in the present embodiment, the user sequentially touches the regions B (t₁), B (t₂), B (t₃), and B (t₄) on the touch interface 120 with his finger 110 over time. Meanwhile, the touch interface 120 sequentially senses the edge changes of the region B (t₁) over time within a specific timing tolerance Δt. Thus, the control unit 130 defines the touch gesture of the user's finger according to the edge changes of the region B (t₁) over time. Herein the timings have such a sequence as t₁<t₂<t₃<t₄.

To be specific, the edge change sensed by the touch interface 120 during the period t₁-t₂ may be in the −X-direction. The edge change sensed by the touch interface 120 during the period t₂-t₃ may be in the +Y-direction. Then, the edge change sensed by the touch interface 120 during the period t₃-t₄ may be in the +X-direction. Herein the direction of the edge change sensed during the period t₂-t₃ is the direction of an edge change between the regions B (t₃) and B (t₁), and the direction of the edge change sensed during the period t₃-t₄ is the direction of an edge change between the regions B (t₄) and B (t₁).

Thus, the control unit 130 defines the touch gesture of the user's finger as a flip gesture (as shown in FIG. 7A) in the horizontal direction according to the edge changes of the region B (t₁) during the periods t₁-t₂, t₂-t₃, and t₃-t₄.

To be specific, in order to prevent the control unit 130 from defining the touch gesture as a moving gesture in the −X-direction according to the direction of the edge change during the period t₁-t₂, the control unit 130 first determines whether an area change of the region B (t₁) satisfies a condition of performing the flip judgment sequence. The control unit 130 performs the flip judgment sequence only if the area change of the region B (t₁) satisfies the condition of performing the flip judgment sequence. For example, if the area change of the region B (t₁) tallies with the area changes of the regions B (t₂) and B (t₃) during the period t₂-t₃, the control unit 130 performs the flip judgment sequence to define the touch gesture of the user's finger as a flip gesture in the horizontal direction.

Additionally, before defining the touch gesture of the user's finger as a flip gesture in the horizontal direction, the control unit 130 first determines whether an angle between the directions of the edge changes sensed at time t₂ and time t₄ is greater than a second angle threshold. If the angle is greater than the second angle threshold, the control unit 130 defines the touch gesture as a flip gesture. For example, in the present embodiment, the angle between the directions of the edge changes sensed at time t₂ and time t₃ is assumed to be the second angle threshold. If the angle between the directions of the edge changes sensed at time t₂ and time t₄ is greater than the angle between the directions of the edge changes sensed at time t₂ and time t₃, the control unit 130 defines the touch gesture as a flip gesture. In the present embodiment, the directions of the edge changes sensed at time t₂ and time t₄ are substantially reverse to each other. Thus, the control unit 130 defines the touch gesture is a flip gesture.

In other words, the control unit 130 performs a flip judgment sequence according to the area change of the touch region and determines whether the angle between the first direction (the direction of the edge change sensed at time t₂) and the second direction (the direction of the edge change sensed at time t₄) is greater than the second angle threshold (the angle between the directions of the edge changes sensed at time t₂ and time t₃). If the angle between the first direction and the second direction is greater than the second angle threshold, the control unit 130 defines the touch gesture as a flip gesture. In the present embodiment, the first direction and the second direction are substantially reverse to each other.

It should be noted that in FIG. 7A, even though the touch region between the finger 110 and the touch interface 120 changes, the finger 110 remains in contact with the touch interface 120 and does not leave the surface of the touch interface 120 during the course of the change. Namely, the regions B (t₁), B (t₂), B (t₃), and B (t₄) at different time points can be substantially considered as the same region, and which are regions on the touch interface 120 corresponding to the same object at different time.

FIG. 7B illustrates how a region on a touch interface touched by a user's finger changes over time according to yet another embodiment of the invention. Referring to FIG. 2 and FIG. 7B, in the present embodiment, the user sequentially touches the regions B′ (t₁), B′ (t₂), B′ (t₃), and B′ (t₄) on the touch interface 120 over time with his finger 110. Meanwhile, the touch interface 120 sequentially senses the edge changes of the region B′ (t₁) over time within a specific timing tolerance Δt. Thus, the control unit 130 defines the touch gesture of the user's finger according to the edge changes of the region B′ (t₁) over time. Herein the timings have such a sequence as t₁<t₂<t₃<t₄.

To be specific, the edge change sensed by the touch interface 120 during the period t₁-t₂ may be in the +Y-direction. The edge change sensed by the touch interface 120 during the period t₂-t₃ may be in the −X-direction. The edge change sensed by the touch interface 120 during the period t₃-t₄ may be in the −Y-direction. Herein the direction of the edge change during the period t₂-t₃ is the direction of an edge change between the regions B′ (t₃) and B′ (t₁), and the direction of the edge change during the period t₃-t₄ is the direction of an edge change between the regions B′ (t₄) and B′ (t₁).

Thus, the control unit 130 defines the touch gesture of the user's finger as a flip gesture in the vertical direction (as shown in FIG. 7B) according to the edge changes of the region B′ (t₁) during the periods t₁-t₂, t₂-t₃, and t₃-t₄.

It should be noted that the value of the second angle threshold (i.e., the angle between the directions of the edge changes sensed at time t₂ and time t₃) in the present embodiment may be the same as or different from that in the embodiment illustrated in FIG. 7A.

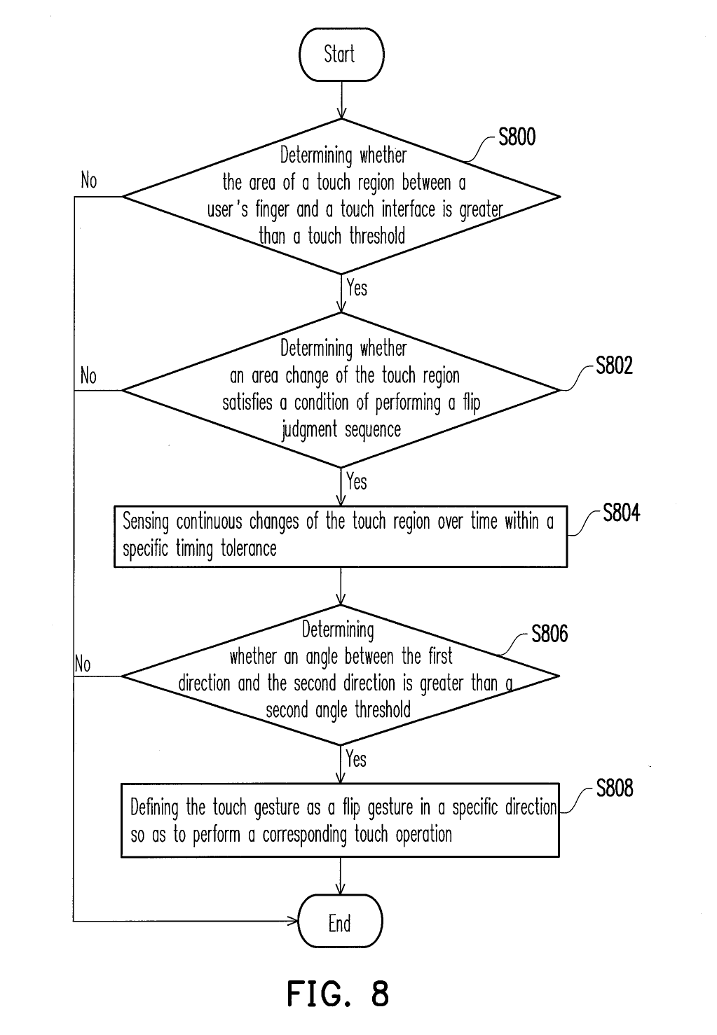

FIG. 8 is a flowchart illustrating the steps in a touch sensing method for defining a flip gesture according to an embodiment of the invention.

Referring to FIG. 8, first, in step S800, whether the area of the touch region between the user's finger and the touch interface is greater than a touch threshold is determined. If the area of the touch region between the user's finger and the touch interface is greater than the touch threshold, in step S802, whether an area change of the touch region satisfies a condition of performing a flip judgment sequence is determined. If the area change of the touch region satisfies the condition of performing the flip judgment sequence, in step S804, continuous changes of the touch region over time are sensed within a specific timing tolerance. Then, in step S806, whether an angle between the first direction and the second direction is greater than a second angle threshold is determined. If the angle between the first direction and the second direction is greater than the second angle threshold, in step S808, the touch gesture is defined as a flip gesture in a specific direction so as to perform a corresponding touch operation.

Besides, the touch sensing method described in this embodiment of the invention is sufficiently taught, suggested, and embodied in the embodiments illustrated in FIG. 7A and FIG. 7B, and therefore no further description is provided herein.

It should be noted that in the embodiments illustrated in FIGS. 1A-8, the touch sensing system 100 senses the edge change of a single-point touch region. However, the invention is not limited thereto, and in other embodiments, the touch sensing system 100 may also sense the edge change of a multi-point touch region so as to define the touch gesture of the user's finger.

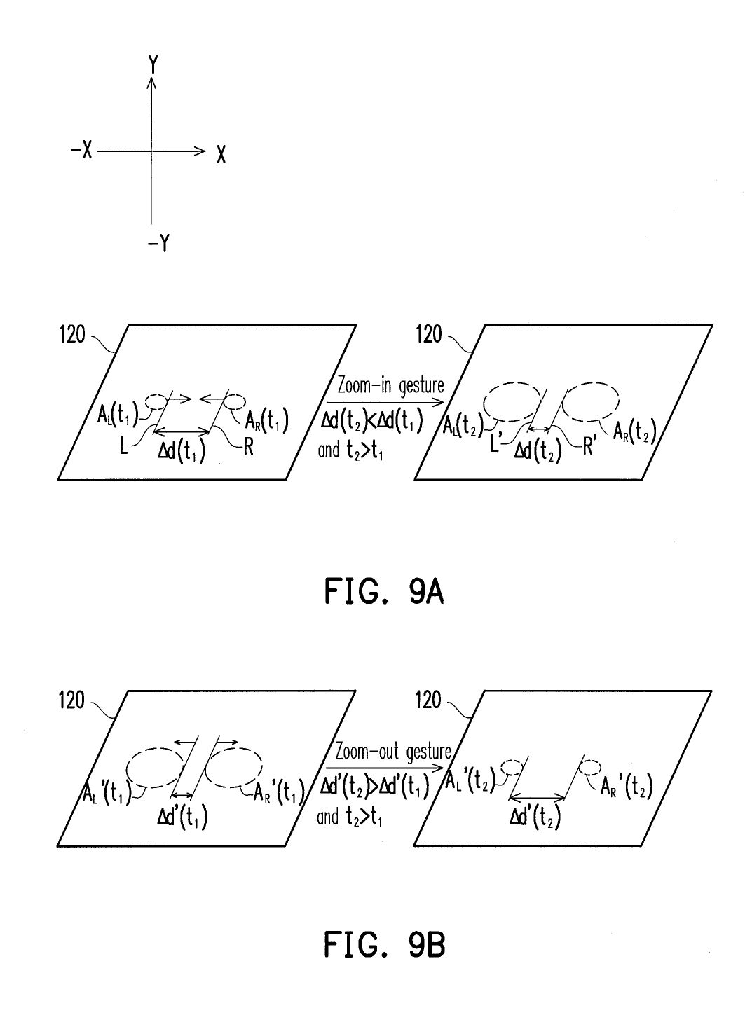

FIG. 9A illustrates edge changes of a multi-touch region according to an embodiment of the invention. Referring to FIG. 2 and FIG. 9A, in the present embodiment, the user touches two regions A_{L} (t₁) and A_{R} (t₁) on the touch interface 120 with his finger 110 at time t₁. Subsequently, the regions A_{L} (t₁) and A_{R} (t₁) are respectively changed to regions A_{L} (t₂) and A_{R} (t₂) at time t₂.

Thus, the touch interface 120 senses the edge changes of the regions A_{L} (t₁) and A_{R} (t₁) over time within the specific timing tolerance Δt. The control unit 130 defines the touch gesture of the user's finger according to the edge changes over time of the regions A_{L} (t₁) and A_{R} (t₁). Herein the timings have such a sequence as t₁<t₂.

To be specific, at time t₁, the touch interface 120 senses the edge tangent of the region A_{L} (t₁) to be L, and at time t₁, the touch interface 120 senses the edge tangent of the region A_{L} (t₂) to be L′. Thus, during the period t₁-t₂, the touch interface 120 senses the edge change of the region A_{L} (t₁) to be an edge change in the +X-direction. Similarly, at time t₁, the touch interface 120 senses the edge tangent of the region A_{R} (t₁) to be R, and at time t₂, the touch interface 120 senses the edge tangent of the region A_{R} (t₂) to be R′. Thus, during the period t₁-t₂, the touch interface 120 senses the edge change of the region A_{R} (t₁) to be an edge change in the −X-direction.

In other words, during the period t₁-t₂, the directions of the edge changes of the regions A_{L} (t₁) and A_{R} (t₁) substantially point to the same target (not shown). Thus, the control unit 130 defines the touch gesture of the user's finger as a zoom-in gesture according to the direction of the edge changes of the regions A_{L} (t₁) and A_{R} (t₁).

On the other hand, at time t₁, the distance between the edge tangents L and R is Δd (t₁), and at time t₂, the distance between the edge tangents L′ and R′ is Δd (t₂). Thus, if the distance Δd (t₁) is greater than the distance Δd (t₂), the control unit 130 defines the touch gesture of the user's finger as a zoom-in gesture according to the directions of the edge changes of the regions A_{L} (t₁) and A_{R} (t₁).

To be specific, in order to prevent the control unit 130 from defining the touch gesture as a moving gesture in the +X-direction according to the direction of the edge change of the region A_{L} (t₁) during the period t₁-t₂, the control unit 130 first determines whether area changes of the regions A_{L} (t₁) and A_{R} (t₁) satisfy a condition of performing a zoom-in judgment sequence. The control unit 130 performs the zoom-in judgment sequence only if the area changes of the regions A_{L} (t₁) and A_{R} (t₁) satisfy the condition of performing the zoom-in judgment sequence. For example, if the area changes of the regions A_{L} (t₁) and A_{R} (t₁) are as illustrated in FIG. 9A during the period t₁-t₂, the control unit 130 performs the zoom-in judgment sequence to define the touch gesture of the user's finger as a zoom-in gesture.

Additionally, before defining the touch gesture of the user's finger as the zoom-in gesture, the control unit 130 first determines whether the distance Δd (t₂) between the edge tangents L′ and R′ at time t₂ is smaller than a first distance threshold. If the distance Δd (t₂) is smaller than the first distance threshold, the control unit 130 defines the touch gesture as a zoom-in gesture.

In other words, the control unit 130 performs a zoom-in judgment sequence according to area changes of a first region (i.e., the region A_{L} (t₁)) and a second region (i.e., the region A_{R} (t₁)) and determines whether the distance (i.e., the distance Δd (t₂)) between the first region and the second region is smaller than a first distance threshold. If the distance between the first region and the second region is smaller than the first distance threshold, the control unit 130 defines the touch gesture as a zoom-in gesture. In the present embodiment, the directions of the edge changes of the regions A_{L} (t₁) and A_{R} (t₁) substantially point to the same target (not shown).

FIG. 9B illustrates edge changes of a multi-touch region according to another embodiment of the invention. Referring to FIG. 2 and FIG. 9B, in the present embodiment, the user touches two regions A_{L}′ (t₁) and A_{R}′ (t₁) on the touch interface 120 with his finger 110 at time t₁. Subsequently, the regions A_{L}′ (t₁) and A_{R}′ (t₁) are respectively changed to regions A_{L} ′ (t₂) and A_{R}′ (t₂) at time t₂.

Thus, the touch interface 120 senses the edge changes over time of the regions A_{L}′ (t₁) and A_{R}′ (t₁) within a specific timing tolerance Δt. The control unit 130 defines the touch gesture of the user's finger according to the edge changes over time of the regions A_{L}′ (t₁) and A_{R}′ (t₁). Herein the timings have such a sequence as t₁<t₂.

In the present embodiment, the directions of the edge changes of the regions A_{L}′ (t₁) and A_{R}′ (t₁) substantially point away from the same target (not shown) during the period t₁-t₂. Thus, the control unit 130 defines the touch gesture of the user's finger as a zoom-out gesture according to the directions of the edge changes of the regions A_{L}′ (t₁) and A_{R}′ (t₁).

On the other hand, at time t₁, the distance between the edge tangents of the regions A_{L}′ (t₁) and A_{R}′ (t₁) is Δd′ (t₁), and at time t₂, the distance between the edge tangents of the regions A_{L}′ (t₂) and A_{R}′ (t₂) is Δd′ (t₂). Thus, if the distance Δd′ (t₁) is smaller than the distance Δd′ (t₂), the control unit 130 defines the touch gesture of the user's finger as a zoom-out gesture according to the directions of the edge changes of the regions A_{L}′ (t₁) and A_{R}′ (t₁).

Similarly, in order to prevent the control unit 130 from defining the touch gesture as a moving gesture in the −X-direction according to the direction of the edge change of the region A_{L}′ (t₁) during the period t₁-t₂, the control unit 130 first determines whether the area changes of the regions A_{L}′ (t₁) and A_{R}′ (t₁) satisfy a condition of performing a zoom-out judgment sequence. The control unit 130 performs the zoom-out judgment sequence only if the area changes of the regions A_{L}′ (t₁) and A_{R}′ (t₁) satisfy the condition of performing the zoom-in judgment sequence. For example, if the area changes of the regions A_{L}′ (t₁) and A_{R}′ (t₁) are as illustrated in FIG. 9B during the period t₁-t₂, the control unit 130 performs the zoom-out judgment sequence to define the touch gesture of the user's finger as a zoom-out gesture.

Additionally, before defining the touch gesture of the user's finger as the zoom-out gesture, the control unit 130 first determines whether the distance Δ′d (t₂) between the edge tangents of the regions A_{L}′ (t₂) and A_{R}′ (t₂) at time t₂ is greater than a second distance threshold. If the distance Δ′d (t₂) is greater than the second distance threshold, the control unit 130 defines the touch gesture as a zoom-out gesture.

In other words, the control unit 130 performs a zoom-out judgment sequence according to the area changes of a first region (i.e., the region A_{L}′ (t₁)) and a second region (i.e., the region A_{R}′ (t₁)) and determines whether the distance (i.e., the distance Δd′ (t₂)) between the first region and the second region is greater than a second distance threshold. If the distance between the first region and the second region is greater than the second distance threshold, the control unit 130 defines the touch gesture as a zoom-out gesture. In the present embodiment, the directions of the edge changes of the regions A_{L}′ (t₁) and A_{R}′ (t₁) substantially point away from the same target (not shown).

It should be noted that in FIG. 9A and FIG. 9B, even though the touch regions A_{L} (t₁), A_{R} (t₁), A_{L}′ (t₁), and A_{R}′ (t₁) between the finger 110 and the touch interface 120 change, the finger 110 remains in contact with the touch interface 120 and does not leave the surface of the touch interface 120 during the course of the change. In addition, in the present embodiment, the touch interface 120 senses the edge changes of multiple touch regions at the same time during the period t₁-t₂ so that the control unit 130 can define the touch gesture of the user's finger accordingly. Moreover, in the embodiment illustrated in FIG. 9A and FIG. 9B, the values of the first distance threshold and the second distance threshold may be the same as or different from each other.

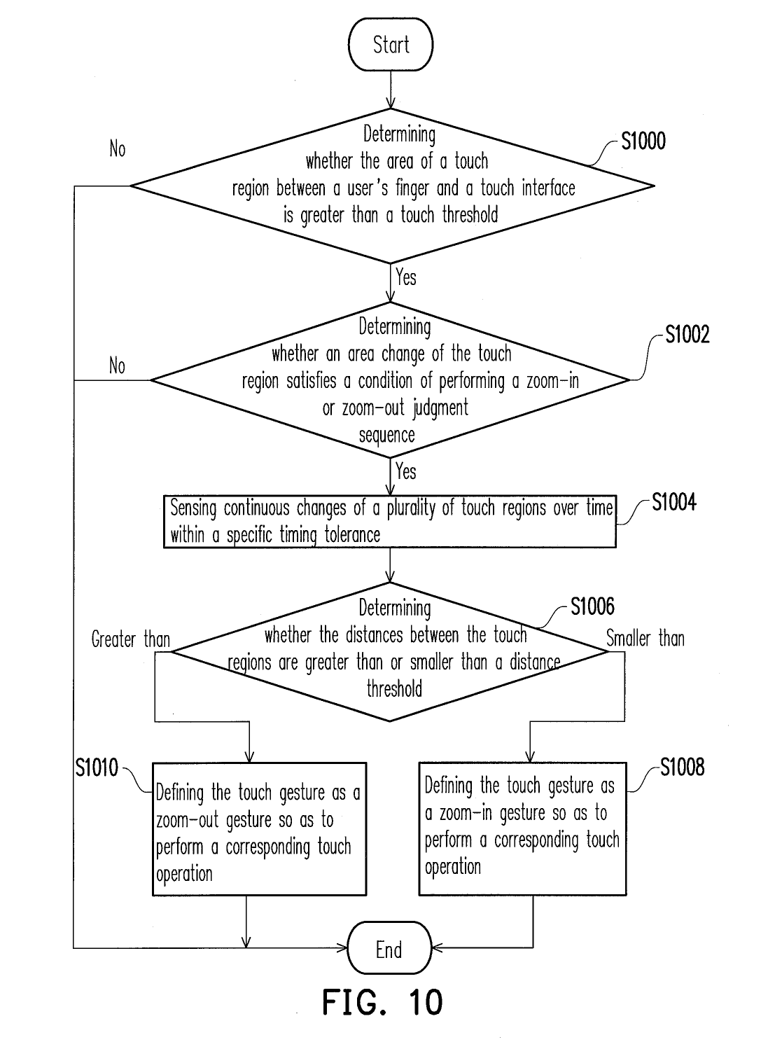

FIG. 10 is a flowchart illustrating the steps in a touch sensing method for defining a zoom-in or a zoom-out gesture according to an embodiment of the invention. Herein the first distance threshold and the second distance threshold are assumed to have the same value.

Referring to FIG. 10, first, in step S1000, whether the area of a touch region between the user's finger and the touch interface is greater than a touch threshold is determined. If the area of the touch region between the user's finger and the touch interface is greater than the touch threshold, in step S1002, whether an area change of the touch region satisfies a condition of performing a zoom-in or zoom-out judgment sequence is determined. If the area change of the touch region satisfies the condition of performing the zoom-in or zoom-out judgment sequence, in step S1004, continuous changes of a plurality of touch regions over time are sensed within a specific timing tolerance. Next, in step S1006, whether the distances between the touch regions are greater than or smaller than a distance threshold (i.e., the first distance threshold or the second distance threshold) is determined. If the distances between the touch regions are smaller than the distance threshold, in step S1008, the touch gesture is defined as a zoom-in gesture so as to perform a corresponding touch operation. If the distances between the touch regions are greater than the distance threshold, in step S1010, the touch gesture is defined as a zoom-out gesture so as to perform a corresponding touch operation.

Besides, the touch sensing method described in this embodiment of the invention is sufficiently taught, suggested, and embodied in the embodiments illustrated in FIG. 9A and FIG. 9B, and therefore no further description is provided herein.

In the embodiment described above, the touch regions between the finger 110 and the touch interface 120 are round regions or elliptical regions. However, it should be understood by those having ordinary knowledge in the art that the invention is not limited thereto, and the touch regions may be in any shape without departing the scope of the invention.

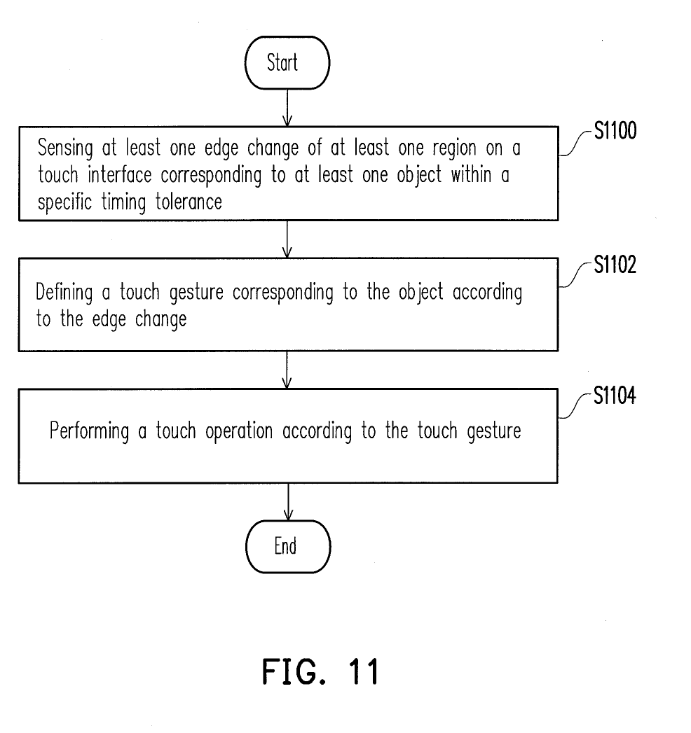

FIG. 11 is a flowchart of a touch sensing method according to an embodiment of the invention. Referring to FIG. 2 and FIG. 11, the touch sensing method in the present embodiment includes following steps. First, in step S1100, at least one edge change of at least one region on the touch interface 120 corresponding to at least one object (for example, a finger of a user) is sensed within a specific timing tolerance Δt. Then, in step S1102, a touch gesture corresponding to the object is defined according to the edge change. Next, in step S1104, a touch operation is performed according to the touch gesture.

Besides, the touch sensing method described in this embodiment of the invention is sufficiently taught, suggested, and embodied in the embodiments illustrated in FIG. 1 to FIG. 10, and therefore no further description is provided herein.

As described above, in a touch sensing system provided by an embodiment of the invention, a touch gesture is defined according to an edge change of a region on the touch interface corresponding to an object, and a corresponding touch operation is performed according to the touch gesture. Additionally, in a touch sensing method provided by an embodiment of the invention, whether a touch gesture is a moving gesture, a rotation gesture, a flip gesture, a zoom-in gesture, or a zoom-out gesture is determined according to any change of a touch region. Thereby, application of touch sensing technique is made more diversified. As to the users, the touch sensing method in embodiments of the invention offers a pseudo 3-dimensional touch sensing mode such that the application of touch sensing technique is made more diversified.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A touch sensing method, adapted to a touch sensing system, wherein the touch sensing system comprises a touch interface, the touch sensing method comprising:
sensing at least one edge change of at least one region on the touch interface corresponding to at least one object within a timing tolerance; and
defining a touch gesture corresponding to the object according to the edge change.

2. The touch sensing method according to claim 1, wherein the step of sensing the edge change comprises:
sensing a first edge of the region in a direction at a first time within the timing tolerance;
sensing a second edge of the region in the direction at a second time within the timing tolerance;
determining whether a distance between the first edge and the second edge is greater than a change threshold; and
defining the distance as the edge change when the distance is greater than the change threshold, wherein a value of the edge change is the distance, and a direction of the edge change is the direction.

3. The touch sensing method according to claim 2, further comprising:
defining the touch gesture as a moving gesture towards the direction according to the direction of the edge change.

4. The touch sensing method according to claim 1, wherein the step of sensing the edge change comprises:
sensing a first edge change of the region during a first period within the timing tolerance; and
sensing a second edge change of the region during a second period within the timing tolerance, wherein a direction of the first edge change is a first direction, and a direction of the second edge change is a second direction.

5. The touch sensing method according to claim 4, further comprising:
performing a rotation judgment sequence according to an area change of the region;
determining whether an angle between the first direction and the second direction is greater than a first angle threshold; and
defining the touch gesture as a rotation gesture when the angle is greater than the first angle threshold.

6. The touch sensing method according to claim 4, further comprising:
performing a flip judgment sequence according to an area change of the region;
determining whether an angle between the first direction and the second direction is greater than a second angle threshold; and
defining the touch gesture as a flip gesture when the angle is greater than the second angle threshold.

7. The touch sensing method according to claim 1, wherein the step of sensing the edge change comprises:
sensing a third edge change of a first region corresponding to the object during a third period within the timing tolerance; and
sensing a fourth edge change of a second region corresponding to the object during the third period within the timing tolerance.

8. The touch sensing method according to claim 7, further comprising:
performing a zoom-in judgment sequence according to area changes of the first region and the second region;
determining whether a distance between the first region and the second region is smaller than a first distance threshold; and
defining the touch gesture as a zoom-in gesture when the distance is smaller than the first distance threshold.

9. The touch sensing method according to claim 7, further comprising:
performing a zoom-out judgment sequence according to area changes of the first region and the second region;
determining whether a distance between the first region and the second region is greater than a second distance threshold; and
defining the touch gesture as a zoom-out gesture when the distance is greater than the second distance threshold.

10. The touch sensing method according to claim 1, further comprising:
performing a touch operation according to the touch gesture.

11. A touch sensing system, comprising:
a touch interface sensing at least one edge change of at least one region on the touch interface corresponding to at least one object within a timing tolerance; and
a control unit defining a touch gesture corresponding to the object according to the edge change.

12. The touch sensing system according to claim 11, wherein when the touch interface senses the edge change, the touch interface senses a first edge of the region in a direction at a first time within the timing tolerance, and the touch interface senses a second edge of the region in the direction at a second time within the timing tolerance, the control unit determines whether a distance between the first edge and the second edge is greater than a change threshold and defines the distance as the edge change when the distance is greater than the change threshold, wherein a value of the edge change is the distance, and a direction of the edge change is the direction.

13. The touch sensing system according to claim 12, wherein the control unit defines the touch gesture as a moving gesture towards the direction according to the direction of the edge change.

14. The touch sensing system according to claim 11, wherein when the touch interface senses the edge change, the touch interface senses a first edge change of the region corresponding to the object during a first period within the timing tolerance, and the touch interface senses a second edge change of the region corresponding to the object during a second period within the timing tolerance, wherein a direction of the first edge change is a first direction, and a direction of the second edge change is a second direction.

15. The touch sensing system according to claim 14, wherein the control unit performs a rotation judgment sequence according to an area change of the region and determines whether an angle between the first direction and the second direction is greater than a first angle threshold, and the control unit defines the touch gesture as a rotation gesture when the angle is greater than the first angle threshold.

16. The touch sensing system according to claim 14, wherein the control unit performs a flip judgment sequence according to an area change of the region and determines whether an angle between the first direction and the second direction is greater than a second angle threshold, and the control unit defines the touch gesture as a flip gesture when the angle is greater than the second angle threshold.

17. The touch sensing system according to claim 11, wherein when the touch interface senses the edge change, the touch interface senses a third edge change of a first region corresponding to the object during a third period within the timing tolerance, and the touch interface senses a fourth edge change of a second region corresponding to the object during the third period within the timing tolerance.

18. The touch sensing system according to claim 17, wherein the control unit performs a zoom-in judgment sequence according to area changes of the first region and the second region and determines whether a distance between the first region and the second region is smaller than a first distance threshold, and the control unit defines the touch gesture as a zoom-in gesture when the distance is smaller than the first distance threshold.

19. The touch sensing system according to claim 17, wherein the control unit performs a zoom-out judgment sequence according to area changes of the first region and the second region and determines whether a distance between the first region and the second region is greater than a second distance threshold, and the control unit defines the touch gesture as a zoom-out gesture when the distance is greater than the second distance threshold.

20. The touch sensing system according to claim 11, wherein the control unit performs a touch operation according to the touch gesture.
